(19) United States
(12) Patent Application Publication
(10) Pub. No.: US 2004/0111307 A1
(43) Pub. Date: Jun. 10, 2004

(54) Electronic calendar management of privately owned resources

(75) Inventors: Scott H. Demsky, Boca Raton, FL (US); Robert M. Szabo, Boca Raton, FL (US)

Correspondence Address: Gregory A. Nelson, Akerman Senterfift, Fourth Floor, 222 Lakeview Avenue, P.O. Box 3188, West Palm Beach, FL, 33402-3188, US

(73) Assignee: International Business Machines Corporation, Armonk, NY (US)

(21) Appl. No.: 10/310,240

(22) Filed: Dec. 4, 2002

(51) Int. Cl. G06F 17/60

(52) U.S. Cl. 705/8

(57) ABSTRACT

Within an electronic calendaring system, a method of scheduling private resources for use with meetings can include, from a client of the meeting notification system, defining a set of private resources for use with meetings. The set of private resources can be available only to a predefined class of users. The method further can include receiving a request to schedule a meeting from a client within the class of users, presenting the set of private resources, and receiving a user selection indicating selected ones of the set of private resources to be used during the meeting. The meeting can be scheduled in the electronic meeting notification system and the selected ones of the set of private resources can be associated with the scheduled meeting.

### BACKGROUND

1. Field of the Invention

The present invention relates to the field of electronic calendaring systems and, more particularly, to arranging meetings through such systems.

2. Description of the Related Art

Multi-party electronic calendaring systems facilitate the scheduling of multi-party meetings. Electronic calendaring systems can determine whether prospective meeting participants are available at designated times, send invitations to join meetings to designated recipients, schedule an agreed upon meeting time, meeting duration, and date within each participant's individual calendar, and perform other collaborative functions such as messaging.

Meeting participants often require the use of one or more resources such as projectors, monitors, computers, and the like, during the course of a meeting. While some conventional calendaring applications attempt to provide resource scheduling functions, such systems are limited to scheduling public resources. Public resources can include any resource that is available to the entire class of calendaring system users, for example any employee with calendaring system access.

Conventional calendaring systems, particularly those with a centrally administered server which interacts with multiple clients, require a system administrator to specify publicly available resources within the centralized server. Accordingly, users are limited to scheduling only those resources which have been defined by the system administrator within the calendaring system. Still, despite the fact that public resources may be reserved in conjunction with a particular meeting, the scheduling of meetings and the scheduling of public resources are treated as two distinct and separate tasks within conventional calendaring systems. That is, one typically schedules a meeting, and then begins a new task to reserve appropriate public resources.

A variety of other resources, however, can exist within an organization. These resources, which are not publicly available to all users, typically are not managed nor tracked by the calendaring system. Such is the case as the potentially large number of available “private” resources, resources which may be owned by an individual, a department, or other sub-part or class of the total user base of the calendaring system, likely would place a significant burden on the system administrator.

In consequence, conventional electronic calendaring systems do not provide for conflict resolution or notification with regard to private meeting resources. As private meeting resources are not tracked by conventional calendaring systems, when scheduling a meeting through such a system, users are unable to determine whether desired private meeting resources will be available. Rather, users must conduct timely, manual searches of equipment reservation logs, whether maintained as soft or hard copies, or interview a librarian or other resource management personnel.

### SUMMARY OF THE INVENTION

The invention disclosed herein provides a method and apparatus for arranging meetings through an electronic calendaring system. The present invention can be used in the context of an electronic meeting notification system, a scheduling system, an electronic mail system, or other communication and/or collaborative system through which users can schedule or notify others of meetings. The present invention allows individual users to define one or more private resources which can be used or scheduled for use in conjunction with a meeting. By allowing individual users to define such private resources, which are not available to the electronic calendaring system user-base at large, the present invention provides flexibility without unduly burdening a system administrator charged with administration of the entire calendaring system.

One aspect of the present invention can include a method of scheduling private resources for use with meetings within an electronic calendaring system. The method can include, responsive to instructions received from a client of the calendaring system, defining a set of private resources, for example physical resources, which are available only to a predefined class of users, for use with or during a meeting. A request to schedule a meeting can be received from a client belonging to the class of users. The request can specify information such as a date, a beginning time, as well as an ending time for the requested meeting.

The set of private resources can be presented through the client. A user selection indicating selected resources of the set of private resources to be used during the meeting can be received and a meeting in the electronic calendaring system can be scheduled. The selected resources of the set of private resources can be associated with the scheduled meetings.

According to one embodiment of the present invention, the method can include detecting whether any of the selected resources of the set of private resources have already been scheduled for another meeting which conflicts with the requested meeting, and if so, notifying the requesting client. Alternatively, the method can include detecting which ones of the set of private resources are available during the requested meeting and presenting only the private resources of the set which are available during the requested meeting.

If the class of users is included within a hierarchy of classes of users, wherein each class of users is associated with a set of private resources, the presenting step can include taking a union of at least two sets of private resources. Each set of private resources used in taking the union can correspond to a class to which a requesting client belongs within the hierarchy of classes. The union of private resources can be presented in the presenting step.

Another aspect of the present invention can include a method of scheduling private resources for use with meetings within an electronic calendaring system, wherein responsive to a client request, a graphical user interface for scheduling a meeting is presented. Within at least one view of the graphical user interface, means for requesting a meeting and means for requesting use, during the meeting, of at least one resource of a set of private resources can be presented. The set of private resources can correspond to a class of users to which the client is associated.

Responsive to activation of the means for requesting at least one private resource, a reference to a private resource view can be dynamically added to the graphical user interface. Responsive to a selection of the dynamically added reference, the private resource view can be displayed. The private resource view can include at least one resource of the set of private resources for use during the requested meeting.

The method also can include receiving a selection in the private resource view which specifies selected ones of the set of private resources for use during the requested meeting. Any selected resources of the set of private resources which have already been scheduled for another meeting which conflicts with the requested meeting can be detected. If conflicts do exist, the requesting client can be notified. Additionally, the method can include detecting which ones of the set of private resources are available during the requested meeting and, responsive to a selection of the dynamically added reference, presenting only the ones of the private resources which are available during the requested meeting within the private resource view.

If the class of users is included within a hierarchy of classes of users such that each class of users is associated with a set of private resources, the displaying step can include taking a union of two or more sets of private resources. The requesting client can be a member of each class which corresponds to the sets of private resources used in taking the union. The classes also can be included within the hierarchy of classes. The presenting step can include presenting the union of private resources.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating an electronic calendaring system in accordance with the inventive arrangements disclosed herein.

FIG. 2 is a flow chart illustrating a method of arranging a meeting in accordance with the present invention.

FIG. 3 is a schematic diagram illustrating a view of a graphical user interface for use with the present invention.

FIG. 4 is a schematic diagram illustrating another view of the graphical user interface of FIG. 3.

### DETAILED DESCRIPTION OF THE INVENTION

The invention disclosed herein provides a method and apparatus for arranging meetings and scheduling the use of private resources in association with arranged meetings. More particularly, the present invention enables users to schedule meetings and the use of private resources through a distributed, electronic calendaring system. Unlike public resources which define a single class of resources which are available to all users having access to the electronic calendaring system, private resources can be made available to a select user or a select class of users, and therefore, allow each individual class of users to be associated with a unique set of private resources.

Additionally, while public resources require a system administrator to define the public resource set as well as maintain the public resources within the calendaring system, the present invention enables any of a variety of individual users to define a set of one or more private resources. The private resources can be associated with the individual user and/or a class of users to which the user belongs. In consequence, without relying upon a system administrator, individual users belonging to a designated class or group of users can define and maintain private resources within a calendaring system. The private resources can be made available only to that user, other members of that user's class, or a sub-class or superset of the user's class.

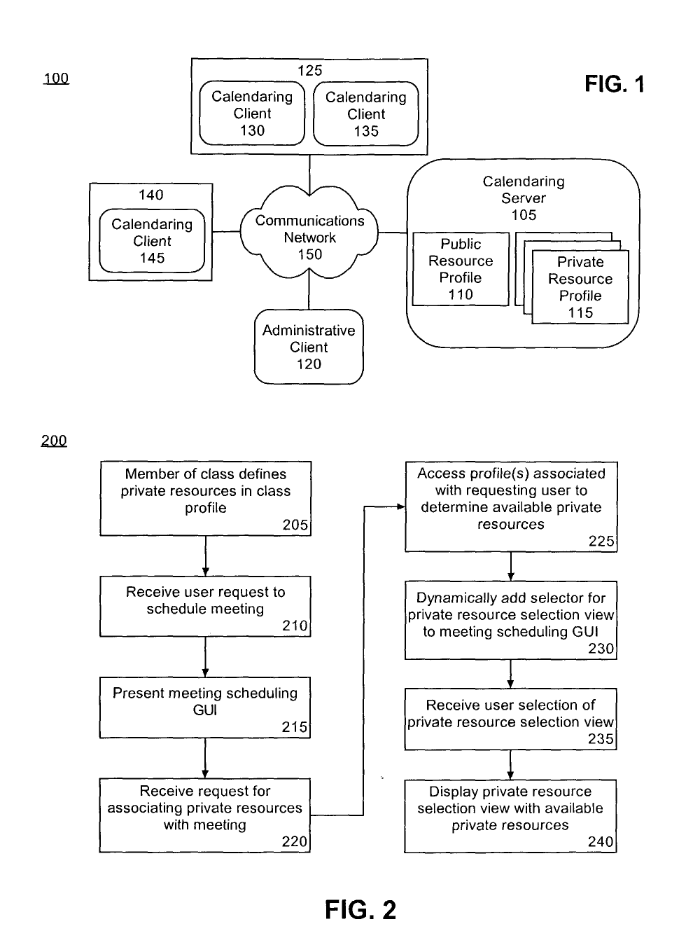

FIG. 1 is a schematic diagram illustrating an exemplary electronic calendaring system 100 in accordance with the inventive arrangements disclosed herein. As shown, the system 100 can include a calendaring server 105, an administrative client 120, user class 125 and 140, each communicatively linked via the communications network 150. The user class 125 can include one or more calendaring system clients such as calendaring clients 130 and 135. Similarly the user class 140 can include one or more calendaring system clients, for example calendaring client 145. It should be appreciated that each user class can include one or more calendaring system clients, through which users can log onto the calendaring system 100. Further, each class of users can be included within a larger class or “super-class”, as well as include one or more sub-classes. As such, the user classes can be ordered in a hierarchical manner.

The calendaring server 105 can include a data store having stored therein, one or more class profiles. More particularly, the calendaring server 105 can include a public resource profile 110 and one or more private resource profiles 115. The public resource profile 110 can specify a listing of available public resources as well as times and dates during which the resource is scheduled for use. Different varieties of public resources which can be listed within the public resources profile 110 can include, but are not limited to, teleconference numbers, physical meeting rooms, office equipment, and the like. As noted, the primary characteristics of public resources are that such resources are made available to the entire or general population of calendaring system users, and that the public resources are administered by a calendaring system administrator.

As noted, the public resources can include any resources which can be made available to the entire set of calendaring system users and/or clients. For example, such public resources can be made available to both user classes 125 and 140. As is typically the case in electronic calendaring systems, a system administrator working through the administrative client 120 must define, maintain, and administer the public resource profile 110. That is, only high level personnel skilled at configuring the calendaring system 100 are provided with the required clearance for defining and administering the public resources due to the possibility that an error can have system wide repercussions.

Similar to the public resource profile 110, each private resource profile 115 can specify a listing of private resources which can be used only by members of the class to which the private resource profile 115 corresponds. Accordingly, one private resource profile 115 can exist and be associated with each defined user class, no matter the number of users included within that class. The private resource profiles 115 can specify times and dates during which the private resource is scheduled for use.

Unlike the public resource profile 110, which must be defined and administered via the administrative client 120, that is a user logged in as an administrator of the electronic calendaring system 100, a private resource profile 115 can be defined and administered by any designated user of the class to which the private resource profile 115 corresponds. By allowing designated members of a class to define and administer private resources, a system administrator need not be burdened with maintaining many different resources and resource profiles for a multitude of groups or classes within an organization. Further, as private resources are to be used by a limited set of calendaring system users, errors with respect to defining and/or administering the private resource profiles 115 do not have system wide repercussions. Rather, any errors or inconsistencies may effect only the class or classes to which that user belongs. Accordingly, by defining private resources, the present invention can schedule private resources of which the larger calendaring system 100 is not aware.

Examples of private resources can include, but are not limited to, department owned or specific pieces of equipment such as televisions, projectors, computers, conference rooms, and the like. So long as the resources are to be used only by a defined subset of the total electronic calendaring system user base, the resource can be considered private. Due to the hierarchical nature of the classes, one or more users can belong to more than one class. In illustration, classes can be defined for business units as well as for various rankings within an organization. In that case, a user can belong to a given business unit class, and also belong to a managerial class. Still, that individual, if in possession of a particular expertise such as speech recognition, also can belong to an expert speech recognition class.

In operation, a user, through the calendaring clients 130, 135, and/or 145 can log onto the calendaring system 100. Through the calendaring clients 130, 135, and 145, users can request meetings, reserve private resources for use during meetings, and send meeting notices to other users. More particularly, each calendaring client can send requests to the calendaring server 105, access information stored within the calendaring server 105, as well as receive communications from the calendaring server 105.

Particular users within the classes of users 125 and 140 can be given the rights to define private resource profiles 115 which correspond to that user's class. Once defined, any user within the same class as the user that defined the private resource profile can schedule meetings and request use, during the meeting, of selected ones of the private resources belonging to that class. The class profiles can be associated with users through any of a variety of possible mechanisms. For example, the class profiles can include a listing of users which are members. Alternatively, each user can be associated with a user profile which specifies the classes to which that user belongs. Accordingly, the user profiles can be cross-referenced against the relevant private resource profiles for the user's associated classes.

FIG. 2 is a flow chart illustrating a method 200 of administering private resources in accordance with the inventive arrangements disclosed herein. The method 200 can begin in a state wherein a member of a class has logged in to the electronic calendaring system. The user can be granted enhanced privileges for defining a set of private resources for the class to which the user belongs. For example, an executive assistant to the leader of a business unit can be provided such access in order to maintain and track private resources available for use only to that business unit (class).

In step 205, the class member can define one or more private resources within a profile corresponding to the class to which that member belongs. For example, an executive assistant can define a grouping of resources for the business unit (class) to which the executive assistant belongs. Once the private resources are defined, the private resources are available for use and scheduling within the electronic calendaring system to members of the class. Accordingly, members of the class can schedule meetings and reserve or associate the private resources with a meeting. Notably, other users which are members of a super-set of the same class also may have access, if desired, to the private resources.

In step 210, the calendaring system can receive a request to schedule a meeting. A member of the class can select an option, whether using a pointer, key commands, and/or voice commands to schedule a meeting. In step 215, the electronic calendaring system, via the user's calendaring client, can present a meeting scheduling graphical user interface (GUI). In step 220, the calendaring system can receive a request for associating private resources with a meeting. For example, via the presented meeting scheduling GUI, the user can select an option indicating that the user would like to schedule one or more private resources for use during the meeting being scheduled.

In step 225, the calendaring system can access profiles associated with the requesting user to determine which private resources are available. More particularly, the class profile or profiles to which the user belongs can be accessed to determine the list of private resources associated with the class or classes. As noted, if the user belongs to one or more different classes, for example in the case where the user belongs to a managerial class, a business class, and/or owns individual resources, for instance where the user is the only member of a class, the calendaring system can take the union of all private resources listed within the various private resource profiles which correspond to the classes to which the user belongs.

In step 230, a selector can be added dynamically to the presented meeting scheduling GUI. The selector can correspond to a view in which various private resources can be presented for selection by a user. In step 235, a user selection of the selector for the private resource view can be received. The user selection can be made via a pointer, a key command, and/or a voice command. In step 240, the private resource view can be displayed.

Notably, although the method 200 describes a dynamically modifiable GUI, the meeting scheduling GUI also can be implemented as a static GUI. That is, the selector for accessing the private resource view can be displayed concurrently when the meeting scheduling GUI is displayed. Further, the listing of private resources displayed within the private resource view can be a static listing obtained from a class profile associated with the requesting user or another user on whose behalf the requesting user is scheduling the meeting and private resources.

Still, as noted, the private resources displayed within the private resource view can be determined dynamically using a variety of different techniques. For example, if the user has already specified times, the calendaring system can filter the list of private resources and retrieve only those private resources which are actually available during the requested time. The calendaring system can display all of the private resources and visually indicate those resources which are not available. If meeting times were not specified prior to the display and selection of private resources within the private resource view, the user can be notified whether the selected private resources are available at such time when the user does specify a meeting time and date. Until the requesting user does specify a meeting time and date, all potentially available private resources can be displayed. Also, as mentioned, the private resources displayed in the private resource view can include a union of various classes to which the user belongs.

It should be appreciated that each of the aforementioned private resource determination techniques can be applied singly, or in various combinations. For example, private resource availability can be determined first by taking the union of classes to which the user belongs and then determining which of the determined private resources is available at the user designated time and date.

Once available private resources have been selected, those resources can be reserved and associated with the meeting being scheduled by the requesting user. For example, particular private resources which have been reserved can be so annotated within a group profile, a data store, a database, or the like. The annotation can specify the date of use, time during which the private resource or resources will be used, as well as any supplemental information concerning the associated meeting in general.

Once associated with one or more meetings, reserved private resources are unavailable to fulfill subsequent requests for use during times which conflict or overlap in time with the meeting times for which the private resource or resources have been scheduled or associated. Any requests for use of the private resources during a time period for which the private resources already have been reserved can be rejected. The requesting user, through the electronic calendaring system, can send a meeting notification to other users also invited to participate within the meeting. A listing of the reserved resources can be included or specified within the meeting notification that is distributed among the participating users.

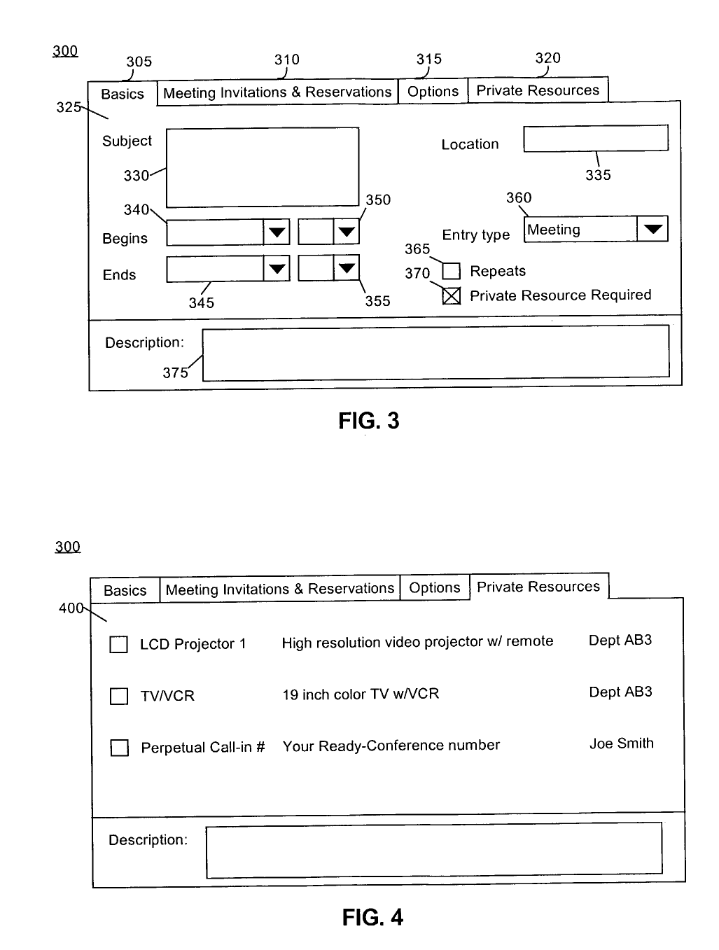

FIG. 3 is a schematic diagram illustrating an exemplary view 325 of a meeting scheduling GUI 300 which can be used with the electronic meeting notification system of FIG. 1 to request a meeting as well as request private resources for use during that meeting. The GUI 300 can include several tabs 305, 310, 315, and 320 for selecting particular views of the GUI 300. As shown, tab 305, entitled “Basic” has been selected, and accordingly, the view 325 which is associated with tab 305 is depicted. View 325 allows a user to specify basic meeting attributes. Thus, a subject field 330 and a location field 335 are provided through which a user can specify subject and location information respectively.

The GUI 300 also can include date selection mechanisms 340 and 345 for specifying the beginning and ending dates of a meeting. Time selection mechanisms 350 and 355 can be provided for specifying beginning and ending meeting times as well. Selection box 360 allows a user to specify an entry type. For example, in this case a user has selected a “meeting” option indicating that the meeting will be an “in-person” meeting rather than a video and/or teleconference. The “Meetings Invitations & Reservations” tab 310 can be associated with a view of the GUI 300 for selecting meeting participants and other details pertaining to the meeting. Further details regarding the meeting can be specified in another view associated with the “Options” tab 315. For example, a user can specify the urgency of the meeting notification to be sent by the calendaring system and/or other delivery options.

Check box 365 allows a user to specify whether the meeting is to repeat. For example, responsive to selecting check box 365, additional selections can be presented for specifying additional meeting times, meeting frequency, and the number of recurring meetings associated with the meeting being scheduled. Check box 370 allows a user to specify whether private resources will be needed for the meeting. Responsive to selection of check box 370, the GUI 300 can dynamically change or adapt. More particularly, the tab 320 need not be initially displayed as part of GUI 300. Responsive to selection of check box 370, however, tab 320 can be added to the GUI 300.

Data entry field 375 allows a user to enter commentary or other supplemental information regarding the meeting. According to one embodiment of the invention, for example, such information can be available only to the meeting requestor and serve as a reminder.

FIG. 4 is a schematic diagram illustrating a view 400 of the GUI of FIG. 3. More particularly, view 400 depicts the private resource view of the GUI 300. The view 400 enables a meeting participant to specify particular private resources required for the meeting being requested. As shown, segment 405 includes three private resource options, an LCD projector, a TV/VCR, and a perpetual conference number, each of which corresponds to a class to which the requesting user belongs.

For example, if the requesting user is “Joe Smith”, or an assistant to “Joe Smith” with access to the supervisor's account, the listing of private resources can include the union of private resources associated with each class to which the user “Joe Smith” belongs. Thus, if the user “Joe Smith” is in “Dept AB3” and also personally has access to a pre-arranged conference number, the union of the two private resource profiles, particularly the private resource profile for “Dept AB3” and the private resource profile for “Joe Smith” can be listed in view 405.

The various GUIs disclosed herein are shown for purposes of illustration only. Accordingly, the present invention is not limited by the particular GUI or data entry mechanisms contained within views of the GUI. Rather, those skilled in the art will recognize that any of a variety of different GUI types and arrangements of data entry fields, selectors, and controls can be used.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. Within a calendaring system, a method of scheduling private resources for use with meetings comprising:
responsive to instructions received from a client of said calendaring system, defining a set of private resources which are available only to a predefined class of users for use with meetings;
receiving a request to schedule a meeting from a client belonging to said class of users;
presenting said set of private resources through said client;
receiving a user selection indicating selected ones of said set of private resources to be used during said meeting;
scheduling said meeting in said electronic calendaring system; and
associating said selected ones of said set of private resources with said scheduled meeting.

2. The method of claim 1, wherein said private resources are physical resources.

3. The method of claim 1, wherein said request specifies at least a date, a beginning time, and an ending time of said requested meeting.

4. The method of claim 3, further comprising:
detecting whether any of said selected ones of said set of private resources have already been scheduled for another meeting which conflicts with said requested meeting; and
if so, notifying said requesting client.

5. The method of claim 3, said presenting step comprising:
detecting which ones of said set of private resources are available during said requested meeting; and
presenting only said ones of said private resources which are available during said requested meeting.

6. The method of claim 1, wherein said class of users is included within a hierarchy of classes of users, wherein each said class of users is associated with a set of private resources, said presenting step further comprising:
taking a union of at least two sets of private resources which correspond to classes, to which a requesting client belongs, within said hierarchy of classes; and
presenting said union of private resources in said presenting step.

7. Within an electronic calendaring system, a method of scheduling private resources for use with meetings comprising:
responsive to a client request, presenting a graphical user interface for scheduling a meeting;
within at least one view of said graphical user interface, presenting means for requesting a meeting and means for requesting use, during said meeting, of at least one resource of a set of private resources which correspond to a class of users to which said client is associated;
responsive to activation of said means for requesting at least one private resource, dynamically adding to said graphical user interface a reference to a private resource view; and
responsive to a selection of said dynamically added reference, displaying said private resource view, wherein said private resource view includes at least one resource of said set of private resources for use during said requested meeting.

8. The method of claim 7, further comprising:
receiving a selection in said private resource view specifying selected ones of said set of private resources for use during said requested meeting.

9. The method of claim 8, further comprising:
detecting whether any of said selected ones of said set of private resources have already been scheduled for another meeting which conflicts with said requested meeting; and
if so, notifying said requesting client.

10. The method of claim 7, said presenting step comprising:
detecting which ones of said set of private resources are available during said requested meeting; and
responsive to a selection of said dynamically added reference, presenting only said ones of said private resources which are available during said requested meeting within said private resource view.

11. The method of claim 7, wherein said class of users is included within a hierarchy of classes of users, wherein each said class of users is associated with a set of private resources, said displaying step further comprising:
taking a union of at least two sets of private resources which correspond to classes, to which said requesting client belongs, within said hierarchy of classes; and
presenting said union of private resources in said presenting step.

12. A machine-readable storage, having stored thereon a computer program having a plurality of code sections executable by a machine for causing the machine to perform the steps of:
responsive to instructions received from a client of a calendaring system, defining a set of private resources which are available only to a predefined class of users for use with meetings;
receiving a request to schedule a meeting from a client belonging to said class of users;
presenting said set of private resources through said client;
receiving a user selection indicating selected ones of said set of private resources to be used during said meeting;
scheduling said meeting in said electronic calendaring system; and
associating said selected ones of said set of private resources with said scheduled meeting.

13. The machine-readable storage of claim 12, wherein said private resources are physical resources.

14. The machine-readable storage of claim 12, wherein said request specifies at least a date, a beginning time, and an ending time of said requested meeting.

15. The machine-readable storage of claim 14, further comprising:
detecting whether any of said selected ones of said set of private resources have already been scheduled for another meeting which conflicts with said requested meeting; and
if so, notifying said requesting client.

16. The machine-readable storage of claim 14, said presenting step comprising:
detecting which ones of said set of private resources are available during said requested meeting; and
presenting only said ones of said private resources which are available during said requested meeting.

17. The machine-readable storage of claim 12, wherein said class of users is included within a hierarchy of classes of users wherein each said class of users is associated with a set of private resources, said presenting step further comprising:
taking a union of at least two sets of private resources which correspond to classes, to which a requesting client belongs, within said hierarchy of classes; and
presenting said union of private resources in said presenting step.

18. A machine-readable storage, having stored thereon a computer program having a plurality of code sections executable by a machine for causing the machine to perform the steps of:
responsive to a client request, presenting a graphical user interface for scheduling a meeting;
within at least one view of said graphical user interface, presenting means for requesting a meeting and means for requesting use, during said meeting, of at least one resource of a set of private resources which correspond to a class of users to which said client is associated;
responsive to activation of said means for requesting at least one private resource, dynamically adding to said graphical user interface a reference to a private resource view; and
responsive to a selection of said dynamically added reference, displaying said private resource view, wherein said private resource view includes at least one resource of said set of private resources for use during said requested meeting.

19. The machine-readable storage of claim 18, further comprising:
receiving a selection in said private resource view specifying selected ones of said set of private resources for use during said requested meeting.

20. The machine-readable storage of claim 19, further comprising:
detecting whether any of said selected ones of said set of private resources have already been scheduled for another meeting which conflicts with said requested meeting; and
if so, notifying said requesting client.

21. The machine-readable storage of claim 18, said presenting step comprising:
detecting which ones of said set of private resources are available during said requested meeting; and
responsive to a selection of said dynamically added reference, presenting only said ones of said private resources which are available during said requested meeting within said private resource view.

22. The machine-readable storage of claim 18, wherein said class of users is included within a hierarchy of classes of users wherein each said class of users is associated with a set of private resources, said displaying step further comprising:
taking a union of at least two sets of private resources which correspond to classes, to which said requesting client belongs, within said hierarchy of classes; and
presenting said union of private resources in said presenting step.
